(19) United States
(12) Patent Application Publication
(10) Pub. No.: US 2017/0300563 A1
(43) Pub. Date: Oct. 19, 2017

(54) GENERATING TEXT SNIPPETS USING SUPERVISED MACHINE LEARNING ALGORITHM

(71) Applicant: LinkedIn Corporation, Mountain View, CA (US)

(72) Inventors: Kevin Kao, San Jose, CA (US); Jeffrey Warren Lee, Cupertino, CA (US); Krishnaram Kenthapadi, Sunnyvale, CA (US)

(21) Appl. No.: 15/099,177

(22) Filed: Apr. 14, 2016

(51) Int. Cl. G06F 17/30; G06N 7/00; G06N 99/00

(52) U.S. Cl. CPC G06F 17/30702; G06N 99/005; G06F 17/30719; G06N 7/005

(57) ABSTRACT

In an example embodiment, a plurality of labeled training documents is obtained, each labeled training document containing a plurality of text snippets. Then, a first set of features is extracted from each text snippet in each of the plurality of labeled training documents. The extracted first set of features and the plurality of labeled training documents are passed to a supervised machine learning algorithm to train a potential snippet relevance score model. A second set of features is extracted from each of a plurality of candidate text snippets in a candidate document. Then, a relevancy score is calculated for each of the plurality of candidate text snippets using the potential snippet relevance score model. Then, one of the plurality of candidate text snippets is selected to display based on the calculated relevancy scores.

### TECHNICAL FIELD

The present disclosure generally relates to computer technology for solving technical challenges in generation of on line data. More specifically, the present disclosure relates to the generating of text snippets using a supervised machine learning algorithm.

### BACKGROUND

There are many instances where the automatic generation of text snippets for display to a computer user is valuable. However, there are technical problems involved in determining how to automatically generate such text snippets. For example, the rise of the Internet has caused the old classified advertisement model of informing potential candidates of job opportunities to migrate towards an on line model. In the on line model, users will often search or otherwise be presented with job listings matching some criteria. Other than the difference in how the job listings are searched or otherwise obtained, however, the on line job searching model is still very similar to the old classified advertisement model. Specifically, the job provider, such as an organization looking to hire, will craft a brief description of the job (called a “job snippet”) to try to accomplish the dual goals of attracting the eye of qualified individuals and reducing the number of unqualified individuals that ultimately apply for the job. Creating such job snippets can be quite difficult.

Additionally, in the realm of on line job listings, user interaction with the job listing can be important not just for the fulfillment of the particular job listing being viewed but also to the company hosting the job listings. Search engine ranking, either within an individual web site or outside via a general search engine, can be influenced by how users interact with a job listing. In other words, the more users click on or otherwise interact with a particular job listing, the higher the particular job listing will be in the rankings of internal searches within a job listing web site, and the higher the job listing web site itself will be ranked in external web searches. Since job snippet effectiveness has a direct correlation to user interaction with a job listing, the effectiveness of a job snippet therefore has a significant impact on search engine ranking inside and outside of a job listing web site.

### BRIEF DESCRIPTION OF THE DRAWINGS

Some embodiments of the technology are illustrated, by way of example and not limitation, in the figures of the accompanying drawings.

FIG. 1 is a block diagram illustrating a client-server system, in accordance with an example embodiment.

FIG. 2 is a block diagram showing the functional components of a social networking service, in accordance with an example embodiment,

FIG. 3 is a block diagram illustrating an application server module in more detail, in accordance with an example embodiment.

FIG. 4 is a diagram illustrating a process flow of a method of automatically generating text snippets in accordance with an example embodiment.

FIG. 5 is a flow diagram illustrating a method for selecting text snippets to display on a computer display, in accordance with an example embodiment.

FIG. 6 is a flow diagram illustrating using a plurality of training documents by a latent topic model unsupervised machine learning algorithm to generate a topic model based on the plurality of training documents, a desired granularity of topics, and a desired number of topics, in more detail, in accordance with an example embodiment.

FIG. 7 is a flow diagram illustrating selecting one of the plurality of candidate texts to display based on the calculated relevancy scores, in more detail, in accordance with an example embodiment.

FIGS, 8-11 represent exemplary user interfaces for receiving information relevant to a job search and returning job snippets, in accordance with an example embodiment.

FIG. 12 is a block diagram illustrating a representative software architecture, which may be used in conjunction with various hardware architectures herein described.

FIG. 13 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

### Overview

The present disclosure describes, among other things, methods, systems, and computer programs. In the following description, for purposes of explanation, numerous specific details are set forth in order to provide a thorough understanding of the various aspects of different embodiments of the present disclosure. It will be evident, however, to one skilled in the art, that the present disclosure may be practiced without all of the specific details.

In an example embodiment, a systematic framework is provided for improving the quality of job snippets. This may include personalizing the job snippets based on the user viewing the job snippet and/or personalizing the job snippets based on parameters of a job listing search. This may all be accomplished using a supervised machine learning algorithm.

It should be noted that the term “organization” as used throughout this document should be interpreted broadly to cover any type of entity having individuals as members or employees. This would include both for-profit and non-profit organizations, as well as entities that may not be considered organizations under some definitions of the term, such as governmental entities, clubs, associations, etc. Organizations are also to be contrasted with individuals. While it is possible that an organization may be comprised of a single member or employee, the organization would still be a distinct entity from the individual and an organization record would still be distinct from an individual record.

In an example embodiment, a neural network is constructed and trained by representing a job as several feature vectors, where each feature vector represents a single sentence or snippet from the job description. These snippets are then scored by the trained neural network, which outputs a ranking score where a higher score is better. A member profile and keywords may be used after the fact to boost and re-rank snippets. With this approach, the snippet generation pipeline can take advantage of additional sources of data (the member profile and keywords) to provide customized snippets tailored to the member's search query. This helps reduce or eliminate results that include empty snippets, snippets with small chunks of highlighted query terms, or snippets merely containing the first X characters of the job description.

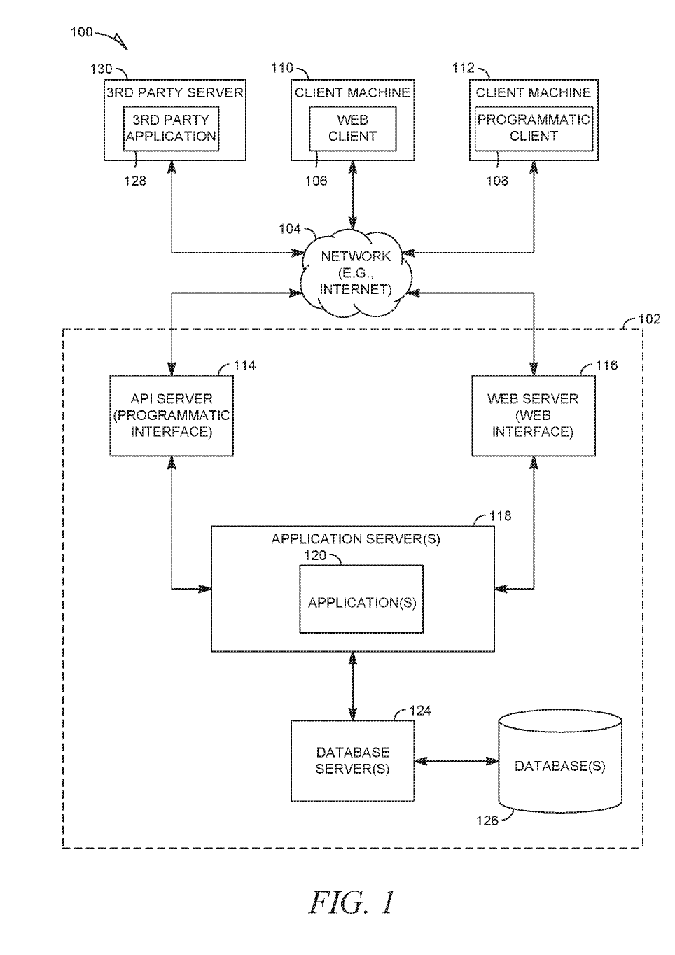

FIG. 1 is a block diagram illustrating a client-server system 100, in accordance with an example embodiment. A networked system 102 provides server-side functionality via a network 104 (e.g., the Internet or a wide area network (WAN)) to one or more clients. FIG. 1 illustrates, for example, a web client 106 (e.g., a browser) and a programmatic client 108 executing on respective client machines 110 and 112.

An application program interface (API) server 114 and a web server 116 are coupled to, and provide programmatic and web interfaces respectively to, one or more application servers 118. The application server(s) 118 host one or more applications 120. The application server(s) 118 are, in turn, shown to be coupled to one or more database servers 124 that facilitate access to one or more databases 126. While the application(s) 120 are shown in FIG. 1 to form part of the networked system 102, it will be appreciated that, in alternative embodiments, the application(s) 120 may form part of a service that is separate and distinct from the networked system 102.

Further, while the client-server system 100 shown in FIG. 1 employs a client-server architecture, the present disclosure is, of course, not limited to such an architecture, and could equally well find application in a distributed, or peer-to-peer, architecture system, for example. The various applications 120 could also be implemented as standalone software programs, which do not necessarily have networking capabilities.

The web client 106 accesses the various services and functions provided by the application(s) 120 via the web interface supported by the web server 116. Similarly, the programmatic client 108 accesses the various services and functions provided by the application(s) 120 via the programmatic interface provided by the API server 114.

FIG. 1 also illustrates a third party application 128, executing on a third party server 130, as having programmatic access to the networked system 102 via the programmatic interface provided by the API server 114. For example, the third party application 128 may, utilizing information retrieved from the networked system 102, support one or more features or functions on a web site hosted by a third party. The third party web site may, for example, provide one or more functions that are supported by the relevant application(s) 120 of the networked system 102.

In some embodiments, any web site referred to herein may comprise on line content that may be rendered on a variety of devices including, but not limited to, a desk top personal computer, a lap top, and a mobile device (e.g., a tablet computer, smartphone, etc.). In this respect, any of these devices may be employed by a user to use the features of the present disclosure. In some embodiments, a user can use a mobile app on a mobile device (any of the client machines 110, 112 and the third party server 130 may be a mobile device) to access and browse on line content, such as any of the on line content disclosed herein. A mobile server (e.g., the API server 114) may communicate with the mobile app and the application server(s) 118 in order to make the features of the present disclosure available on the mobile device.

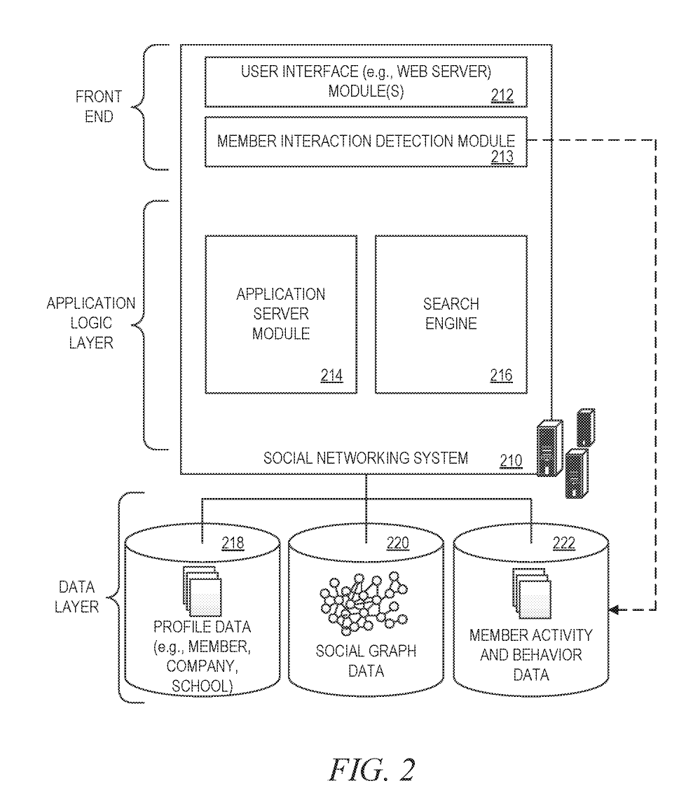

In some embodiments, the networked system 102 may comprise functional components of a social networking service. FIG. 2 is a block diagram showing the functional components of a social networking service, including a data processing module referred to herein as a search engine 216, for use in generating and providing search results for a search query, consistent with some embodiments of the present disclosure. In some embodiments, the search engine 216 may reside on the application server(s) 118 in FIG. 1. However, it is contemplated that other configurations are also within the scope of the present disclosure.

As shown in FIG. 2, a front end may comprise user interface module(s) (e.g., a web server 116) 212, which receives requests from various client computing devices, and communicates appropriate responses to the requesting client devices. For example, the user interface module(s) 212 may receive requests in the form of Hypertext Transfer Protocol (HTTP) requests or other web-based API requests. In addition, a member interaction detection module 213 may be provided to detect various interactions that members have with different application(s) 120, services, and content presented. As shown in FIG. 2, upon detecting a particular interaction, the member interaction detection module 213 logs the interaction, including the type of interaction and any metadata relating to the interaction, in a member activity and behavior database 222.

An application logic layer may include one or more various application server modules 214, which, in conjunction with the user interface module(s) 212, generate various user interfaces (e.g., web pages) with data retrieved from various data sources in a data layer. In some embodiments, individual application server modules 214 are used to implement the functionality associated with various application(s) 120 and/or services provided by the social networking service.

As shown in FIG. 2, the data layer may include several databases, such as a profile database 218 for storing profile data, including both member profile data and profile data for various organizations (e.g., companies, schools, etc.). Consistent with some embodiments, when a person initially registers to become a member of the social networking service, the person will be prompted to provide some personal information, such as his or her name, age (e.g., birthdate), gender, interests, contact information, home town, address, spouse's and/or family members' names, educational background (e.g., schools, majors, matriculation and/or graduation dates, etc.), employment history, skills, professional organizations, and so on. This information is stored, for example, in the profile database 218. Similarly, when a representative of an organization initially registers the organization with the social networking service, the representative may be prompted to provide certain information about the organization. This information may be stored, for example, in the profile database 218, or another database (not shown). In some embodiments, the profile data may be processed (e.g., in the background or off line) to generate various derived profile data. For example, if a member has provided information about various job titles the member has held with the same organization or different organizations, and for how long, this information can be used to inter or derive a member profile attribute indicating the member's overall seniority level, or seniority level within a particular organization. In some embodiments, importing or otherwise accessing data from one or more externally hosted data sources may enrich profile data for both members and organizations. For instance, with organizations in particular, financial data may be imported from one or more external data sources, and made part of an organization's profile. This importation of organization data and enrichment of the data will be described in more detail later in this document.

Once registered, a member may invite other members, or be invited by other members, to connect via the social networking service. A “connection” may constitute a bilateral agreement by the members, such that both members acknowledge the establishment of the connection. Similarly, in some embodiments, a member may elect to “follow” another member. In contrast to establishing a connection, the concept of “following” another member typically is a unilateral operation and, at least in some embodiments, does not require acknowledgement or approval by the member that is being followed. When one member follows another, the member who is following may receive status updates (e.g., in an activity or content stream) or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed, commonly referred to as an activity stream or content stream. In any case, the various associations and relationships that the members establish with other members, or with other entities and objects, are stored and maintained within a social graph in a social graph database 220.

As members interact with the various application(s) 120, services, and content made available via the social networking service, the members' interactions and behavior (e.g., content viewed, links or buttons selected, messages responded to, etc.) may be tracked, and information concerning the members' activities and behavior may be logged or Mored, for example, as indicated in FIG. 2, in the member activity and behavior database 222. This logged activity information may then be used by the search engine 216 to determine search results for a search query.

In some embodiments, the databases 218, 220, and 222 may be incorporated into the database(s) 126 in FIG. 1. However, other configurations are also within the scope of the present disclosure.

Although not shown, in some embodiments, the social networking system 210 provides an API module via which the application(s) 120 and services can access various data and services provided or maintained by the social networking service. For example, using an API, an application 120 may be able to request and/or receive one or more navigation recommendations. Such application(s) 120 may be browser-based application(s) 120, or may be operating system—specific. In particular, some applications 120 may reside and execute (at least partially) on one or more mobile devices (e.g., phone or tablet computing devices) with a mobile operating system. Furthermore, while in many cases the application(s) 120 or services that leverage the API may be application(s) 120 and services that are developed and maintained by the entity operating the social networking service, nothing other than data privacy concerns prevents the API from being provided to the public or to certain third parties under special arrangements, thereby making the navigation recommendations available to third party applications 128 and services.

Although the search engine 216 is referred to herein as being used in the context of a social networking service, it is contemplated that it may also be employed in the context of any web site or on line services. Additionally, although features of the present disclosure are referred to herein as being used or presented in the context of a web page, it is contemplated that any user interface view (e.g., a user interface on a mobile device or on desk top software) is within the scope of the present disclosure.

In an example embodiment, when member profiles are indexed, forward search indexes are created and stored. The search engine 216 facilitates the indexing and searching for content within the social networking service, such as the indexing and searching for data or information contained in the data layer, such as profile data (stored, e.g., in the profile database 218), social graph data (stored, e.g., in the social graph database 220), and member activity and behavior data (stored, e.g., in the member activity and behavior database 222). The search engine 216 may collect, parse, and/or store data in an index or other similar structure to facilitate the identification and retrieval of information in response to received queries for information. This may include, but is not limited to, forward search indexes, inverted indexes, N-gram indexes, and so on,

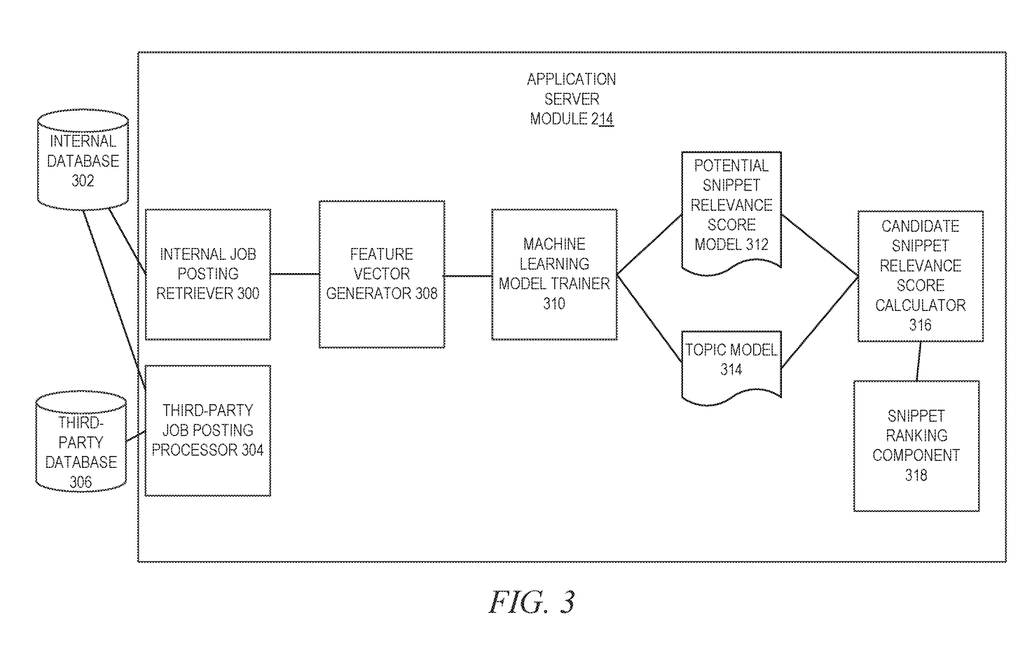

FIG. 3 is a block diagram illustrating application server module 214 of FIG. 2 in more detail. While in many embodiments the application server module 214 will contain many sub components used to perform various different actions within the social networking system 210, in FIG. 3 only those components that are relevant to the present disclosure are depicted. An internal job posting retriever 300 acts to obtain job postings from an internal database 302 and generate one or more candidate snippets from each job posting. The internal database 302 is operated by the same entity that operates the application server module 214, but otherwise does not need to be integrated inside the application server module 214, and hence it is depicted here as being outside the application server module 214. A third-party job posting processor 304 acts to process job postings from a third party database 306. This processing generally involves retrieving (i.e., “scraping”) job postings from one or more third-party databases 306 and processing them for inclusion in internal database 302, where the job postings may be indexed and searched by members of the social networking service.

A feature vector generator 308 acts to generate a feature vector for each candidate snippet from job posting that is fed to it from the internal job posting retriever 300. This may include sample labelled job postings that are to be used during training of the machine learning algorithm(s) as well as candidate job postings that are to be evaluated by the machine learning model(s) for generation of job snippets from the candidate job postings.

A machine learning model trainer 310 acts to use feature vectors for sample labelled job postings from the feature vector generator 308 as well as labels extracted from the sample labelled job postings to train machine learning models. In an example embodiment, there are two separate machine learning models trained by the machine learning model trainer 310: a potential snippet relevance score model 312 and a latent topic model 314. The potential snippet relevance score model 312 may be, for example, a supervised machine learning model such as a neural network, which takes as input a feature vector representing each<document, candidate snippet>pair from the feature vector generator 308 and outputs a potential snippet candidate score (e.g., between 0 and 1, where 1 indicates the most promising snippet). Because the neural network is trained using a supervised learning algorithm, in some example embodiments it may be simpler to create input and output data pairs that themselves are labelled rather than merely relying on labels in the sample job postings themselves. These data pairs can be collected using a crowd sourcing method or through inspection. For the crowd sourced method, subjects can be asked to determine if a particular snippet would be a good snippet for a job based on its description, and the answers can be added as labels to create the labelled output data pairs used to train the potential snippet relevance score model 312. For the inspection method, certain domain specific keywords and phrases such as “responsible for” and “equal employment opportunity” can be used to automatically identify good and bad snippets respectively. In this example embodiment, a list of “good” keywords and phrases is maintained along with a separate list of “bad” keywords and phrases. It should be noted that in some example embodiments, other types of supervised machine learning algorithms may be used other than neural networks. Examples include Random Forests, Decision Trees, Gradient Boosting Machines, and SVM with RBF (nonlinear) kernel.

The latent topic model 314 is trained using an unsupervised machine learning algorithm. Inputs to this unsupervised machine learning algorithm include (1) a large number of documents that might be useful in learning relevant topics (2) a desired number of topics; and (3) desired granularity of the topic model. The large number of documents that might be useful in learning relevant topics may be any type of document, and is not limited to job listings and/or snippets from job listings. For example, in a professional social networks, relevant document types may include job listings, member profiles, news articles, etc. The granularity of the topic model indicates what level of depth the topics should be selected from. For example, the granularity could be any one of job title, job function, job industry, etc.

The unsupervised machine learning algorithm first extracts atomic units of text from the documents that might be useful in learning relevant topics. Then a process called Latent Dirichlet Allocation (LDA) is used to learn latent topics based on the atomic text units, using the desired number of topics and desired granularity of the topic model as parameters to the LDA process. LDA is a generative statistical model that allows sets of observations to be explained by unobserved groups that explain why some parts of the data are similar. Specifically, if topics are correlated in a document, there is a tendency for the algorithm to deduce that they are similar to each other. The more correlations in documents, the more similar the topics. The LDA algorithm identifies the broad classes of topics, and with each topic it saves a list of terms along with weights for each term (the weights indicating how related the term is to the topic). For a given document, the distribution over the topics is obtained. The result is a topic model having a list of topics and, for each topic, the list of related terms with weights for each term.

In LDA, each document is viewed as a mixture of various topics. The topic distribution is assumed to have a Dirichlet prior. The Dirichlet prior is a family of continuous multivariate probability distributions parameterized by a vector of positive reals. It is a multivariate generalization of a beta distribution.

The Dirichlet distribution of order K≧2with parameters α1, . . . , αK>0has a probability density function with respect to Lebesgue measure on the Euclidean space RK-1 given by

$$f ( {x}_{1} , … , {x}_{K} ; {α}_{1} , … , {α}_{K} ) = \frac{1}{B ( α )} {\prod }_{i = 1}^{K} {x}_{i}^{{α}_{i} - 1} ,$$

on the open (K−1)-dimensional simplex defined by:

x₁, . . . , x_{K-1}>0

x₁+ . . . +x_{K-1}<1

x_{K}=1−x₁− . . . −x_{K-1}

and zero elsewhere:

The normalizing constant is the multinomial Beta function, which can be expressed in terms of the gamma function:

$$B ( α ) = \frac{{\prod }_{i = 1}^{K} Γ ( {α}_{i} )}{Γ ( {\sum }_{i = 1}^{K} {α}_{i} )} , α = ( {α}_{1} , … , {α}_{K} ) .$$

With plate notation, the dependencies among the many variables can be captured concisely. The boxes are “plates” representing replicates, The outer plate represents documents, while the inner plate represents the repeated choice of topics and words within a document. M denotes the number of documents, N the number of words in a document, Thus:

α is the parameter of the Dirichlet prior on the per-document topic distributions,

β is the parameter of the Dirichlet prior on the per-topic word distribution,

θᵢ is the topic distribution for document i,

φ_{K} is the word distribution for topic k,

zᵢⱼ is the topic for the j^{th} word in document i, and

wᵢⱼ is the specific word.

The wᵢⱼ are the only observable variables, and the other variables are latent variables. Mostly, the basic LDA model will be extended to a smoothed version to gain better results. The plate notation is shown on the tight, where K denotes the number of topics considered in the model and:

φ is a K*V (V is the dimension of the vocabulary) Markov matrix (transition matrix), and each row of which denotes the word distribution of a topic.

The generative process is as follows. Documents are represented as random mixtures over latent topics, where each topic is characterized by a distribution over words. LDA assumes the following generative process for a corpus D consisting of M documents each of length Nᵢ:

1. Choose θᵢ˜Dir(α), where i ∈ {1, . . . , M} and Dir(α), is the Dirichlet distribution for parameter α.

2. Choose φₖ˜Dir(β), where k ∈ {1, . . . , K}

3. For each of the word positions i, j, where j ∈ {1, . . . Nᵢ}, and i ∈ {1, . . . , M}

(a) Choose a topic z_{i,j}˜Multinomial (θᵢ).

(b) Choose a word w_{i,j}˜Multinomial(φ_{z}_{_{i,j}}

(Note that the multinomial distribution here refers to the multinomial with only one trial. It is formally equivalent to the categorical distribution.)

The lengths Nᵢ are treated as independent of all the other data generating variables (w and z).

Learning the various distributions (the set of topics, their associated word probabilities, the topic of each word, and the particular topic mixture of each document) is a problem of Bayesian inference. The original paper used a variational Bayes approximation of the posterior distribution,[1] alternative inference techniques use Gibbs sampling[6] and expectation propagation.[7]

Following is the derivation of the equations for collapsed Gibbs sampling, which means φs and θs will be integrated out. For simplicity, in this derivation the documents are all assumed to have the same length N. The derivation is equally valid if the document lengths vary.

According to the model, the total probability of the model is:

$$P ( W , Z , θ , ϕ ; α , β ) = {\prod }_{i = 1}^{K} P ( {ϕ}_{i} ; β ) {\prod }_{j = 1}^{M} P ( {θ}_{j} ; a ) {\prod }_{t = 1}^{N} P ( {Z}_{j , t} \vert {θ}_{j} ) P ( {W}_{j , t} \vert ϕ {z}_{j , t} ) ,$$

where the bold-font variables denote the vector version of the variables. First of all, φ and θ need to be integrated out.

$$\begin{matrix}P ( Z , W ; α , β ) = {\int }_{θ} {\int }_{ϕ} {\prod }_{i = 1}^{K} P ( W , Z , θ , ϕ ; α , β ) d ϕ d θ \\ = {\int }_{ϕ} {\prod }_{i = 1}^{K} P ( {ϕ}_{i} ; β ) {\prod }_{j = 1}^{M} {\prod }_{t = 1}^{N} P ( {W}_{j , t} \vert {{ϕ}_{z}}_{j , t} ) d ϕ \\ {\int }_{θ} {\prod }_{j = 1}^{M} P ( {θ}_{j} ; α ) {\prod }_{t = 1}^{N} P ( {Z}_{j , t} \vert {θ}_{j} ) d θ .\end{matrix}$$

All the θs are independent to each other and the same to all the φs. So we can treat each θ and each φ separately. We now focus only on the θ part.

$${\int }_{θ} {\prod }_{j = 1}^{M} P ( {θ}_{j} ; α ) {\prod }_{t = 1}^{N} P ( {Z}_{j , t} \vert {θ}_{j} ) d θ = {\prod }_{j = 1}^{M} {\int }_{{θ}_{j}} P ( {θ}_{j} ; α ) {\prod }_{t = 1}^{N} P ( {Z}_{j , t} \vert {θ}_{j} ) d {θ}_{j} .$$

We can further focus on only one θ as the following:

$${\int }_{{θ}_{j}} P ( {θ}_{j} ; α ) {\prod }_{t = 1}^{N} P ( {Z}_{j , t} \vert {θ}_{j} ) d {θ}_{j} .$$

Actually, it is the hidden part of the model for the j^{th} document. Now we replace the probabilities in the above equation by the true distribution expression to write out the explicit equation.

$${\int }_{{θ}_{j}} P ( {θ}_{j} ; α ) {\prod }_{t = 1}^{N} P ( {Z}_{j , t} \vert {θ}_{j} ) d {θ}_{j} = {\int }_{{θ}_{j}} \frac{Γ ( {\sum }_{i = 1}^{K} {α}_{i} )}{{\prod }_{i = 1}^{K} Γ ( {α}_{i} )} {\prod }_{i = 1}^{K} {θ}_{j , i}^{{α}_{i} - 1} {\prod }_{t = 1}^{N} P ( {Z}_{j , t} \vert {θ}_{j} ) d {θ}_{j} .$$

Let nⁱ_{j,r} or be the number of word tokens in the j^{th} document with the same word symbol (the r^{th} word in the vocabulary) assigned to the i^{th} topic. So, nⁱ_{j,r} is three dimensional. If any of the three dimensions is not limited to a specific value, we use a parenthesized point (·) to denote. For example, nⁱ_{j, (·)} denotes the number of word tokens in the j ^{th} document assigned to the i^{th} topic. Thus, the right most part of the above equation can be rewritten as:

$${\prod }_{t = 1}^{N} P ( {Z}_{j , t} \vert {θ}_{j} ) = {\prod }_{i = 1}^{K} {θ}_{j , i}^{{n}_{j , ( \cdot )}^{ i}}$$

So the θⱼ integration formula can be changed to:

$${\int }_{{θ}_{j}} \frac{Γ ( {\sum }_{i = 1}^{K} {α}_{i} )}{{\prod }_{i = 1}^{K} Γ ( {α}_{i} )} {\prod }_{i = 1}^{K} {θ}_{j , i}^{{α}_{i} - 1} {\prod }_{i = 1}^{K} {θ}_{j , i}^{{n}_{j , ( \cdot )}^{ i}} d {θ}_{j} = {\int }_{{θ}_{j}} \frac{Γ ( {\sum }_{i = 1}^{K} {α}_{i} )}{{\prod }_{i = 1}^{K} Γ ( {α}_{i} )} {\prod }_{i = 1}^{K} {θ}_{j , i}^{{n}_{j , ( \cdot )}^{ i} + {α}_{i} - 1} d {θ}_{j} .$$

Clearly, the equation inside the integration has the same form as the Dirichlet distribution. According to the Dirichlet distribution,

$${\int }_{{θ}_{j}} \frac{Γ ( {\sum }_{i = 1}^{K} {n}_{j , ( \cdot )}^{ i} + {α}_{i} )}{{\prod }_{i = 1}^{K} Γ ( {n}_{j , ( \cdot )}^{ i} + {α}_{i} )} {\prod }_{i = 1}^{K} {θ}_{j , i}^{{n}_{j , ( \cdot )}^{ i} + {α}_{i} - 1} d {θ}_{j} = 1. \\ Thus , \\ {\int }_{{θ}_{j}} P ( {θ}_{j} ; α ) {\prod }_{t = 1}^{N} P ( {Z}_{j , t} \vert {θ}_{j} ) d {θ}_{j} = {\int }_{{θ}_{j}} \frac{Γ ( {\sum }_{i = 1}^{K} {α}_{i} )}{{\prod }_{i = 1}^{K} Γ ( {α}_{i} )} {\prod }_{i = 1}^{K} {θ}_{j , i}^{{n}_{j , ( \cdot )}^{ i} + {α}_{i} - 1} d {θ}_{j} = \frac{Γ ( {\sum }_{i = 1}^{K} {α}_{i} )}{{\prod }_{i = 1}^{K} Γ ( {α}_{i} )} \frac{{\prod }_{i = 1}^{K} Γ ( {n}_{j , ( \cdot )}^{ i} + {α}_{i} )}{ Γ ( {\sum }_{i = 1}^{K} {n}_{j , ( \cdot )}^{ i} + {α}_{i} )} {\int }_{{θ}_{j}} \frac{Γ ( {\sum }_{i = 1}^{K} {n}_{j , ( \cdot )}^{ i} + {α}_{i} )}{{\prod }_{i = 1}^{K} Γ ( {n}_{j , ( \cdot )}^{ i} + {α}_{i} )} {\prod }_{i = 1}^{K} {θ}_{j , i}^{{n}_{j , ( \cdot )}^{ i} + {α}_{i} - 1} d {θ}_{j} = \frac{Γ ( {\sum }_{i = 1}^{K} {α}_{i} )}{{\prod }_{i = 1}^{K} Γ ( {α}_{i} )} \frac{{\prod }_{i = 1}^{K} Γ ( {n}_{j , ( \cdot )}^{ i} + {α}_{i} )}{ Γ ( {\prod }_{i = 1}^{K} {n}_{j , ( \cdot )}^{ i} + {α}_{i} )} .$$

Now we turn our attention to theθ part. Actually, the derivation of the θ part is very similar to theθ part. Here we only list the steps of the derivation:

$${\int }_{ϕ} {\prod }_{i = 1}^{K} P ( {ϕ}_{i} ; β ) {\prod }_{j = 1}^{M} {\prod }_{t = 1}^{N} P ( {W}_{j , t} \vert ϕ {z}_{j , t} ) d ϕ = {\prod }_{i = 1}^{K} {\int }_{{ϕ}_{i}} P ( {ϕ}_{i} ; β ) {\prod }_{j = 1}^{M} {\prod }_{t = 1}^{N} P ( {W}_{j , t} \vert ϕ {z}_{j , t} ) d {ϕ}_{i} = {\prod }_{i = 1}^{K} {\int }_{{ϕ}_{i}} \frac{Γ ( {\sum }_{r = 1}^{V} {β}_{r} )}{{\prod }_{r = 1}^{V} Γ ( {β}_{r} )} {\prod }_{r = 1}^{V} {ϕ}_{i , r}^{ {β}_{r} - 1} {\prod }_{r = 1}^{V} {ϕ}_{i , r}^{{n}_{( \cdot ) , r}^{ i}} d {ϕ}_{i} = {\prod }_{i = 1}^{K} {\int }_{{ϕ}_{i}} \frac{Γ ( {\sum }_{r = 1}^{V} {β}_{r} )}{{\prod }_{r = 1}^{V} Γ ( {β}_{r} )} {\prod }_{r = 1}^{V} {ϕ}_{i , r}^{{n}_{( \cdot ) , r}^{ i} + {β}_{r} - 1} d {ϕ}_{i} = {\prod }_{i = 1}^{K} \frac{Γ ( {\sum }_{r = 1}^{V} {β}_{r} )}{{\prod }_{r = 1}^{V} Γ ( {β}_{r} )} \frac{{\sum }_{r = 1}^{V} Γ ( {n}_{( \cdot ) , r}^{ i} + {β}_{r} )}{Γ ( {\prod }_{r = 1}^{V} {n}_{( \cdot ) , r}^{ i} + {β}_{r} )} .$$

For clarity, here we write down the final equation with bothφ and θ integrated out:

$$P ( Z , W ; α , β ) = {\prod }_{j = 1}^{M} \frac{Γ ( {\sum }_{i = 1}^{K} {α}_{i} )}{{\prod }_{i = 1}^{K} Γ ( {α}_{i} )} \frac{{\prod }_{i = 1}^{K} Γ ( {n}_{j , ( \cdot )}^{ i} + {α}_{i} )}{ Γ ( {\sum }_{i = 1}^{K} {n}_{j , ( \cdot )}^{ i} + {α}_{i} )} \times {\prod }_{i = 1}^{K} \frac{Γ ( {\sum }_{r = 1}^{V} {β}_{r} )}{{\prod }_{r = 1}^{V} Γ ( {β}_{r} )} \frac{{\prod }_{r = 1}^{V} Γ ( {n}_{( \cdot ) , r}^{ i} + {β}_{r} )}{Γ ( {\sum }_{r = 1}^{V} {n}_{( \cdot ) , r}^{ i} + {β}_{r} )} .$$

The goal of Gibbs sampling here is to approximate the distribution of P(Z|W;α,β). Since P(W;α,β) is invariable for any of Z, Gibbs sampling equations can be derived from P(Z|W;α,β) directly. The key point is to derive the following conditional probability:

$$P ( {Z}_{( m , n )} \vert {Z}_{- ( m , n )} , W ; α , β ) = \frac{P ( {Z}_{( m , n )} \vert {Z}_{- ( m , n )} , W ; α , β )}{P ( {Z}_{- ( m , n )} , W ; α , β )} ,$$

where Z_{(m,n)} denotes the Z hidden variable of the n^{th} word token in the m^{th} document. And further we assume that the word symbol of it is the V^{th} word in the vocabulary. Z_{-(m,n)} denotes all the Z s but Z_{(m,n)}. Note that Gibbs sampling needs only to sample a value for Z_{(m,n)}, according to the above probability; we do not need the exact value of P(Z_{m,n}|Z_{-(m,n)},W;α,β) but the ratios among the probabilities that Z_{(m,n)} can take value. So, the above equation can be simplified as

$$P ( {Z}_{( m , n )} = k \vert {Z}_{- ( m , n )} , W ; α , β ) ∝ P ( {Z}_{( m , n )} = k \vert {Z}_{- ( m , n )} , W ; α , β ) = {( \frac{Γ ( {\sum }_{i = 1}^{K} {α}_{i} )}{{\prod }_{i = 1}^{K} Γ ( {α}_{i} )} )}^{M} {\prod }_{j \neq m} \frac{{\prod }_{i = 1}^{K} Γ ( {n}_{j , ( \cdot )}^{ i} + {α}_{i} )}{ Γ ( {\sum }_{i = 1}^{K} {n}_{j , ( \cdot )}^{ i} + {α}_{i} )} \times {( \frac{Γ ( {\sum }_{r = 1}^{V} {β}_{r} )}{{\prod }_{r = 1}^{V} Γ ( {β}_{r} )} )}^{K} {\prod }_{i = 1}^{K} {\prod }_{r \neq v} Γ ( {n}_{( \cdot ) , r}^{ i} + {β}_{r} ) \times \frac{{\prod }_{i = 1}^{K} Γ ( {n}_{m , ( \cdot )}^{ i} + {α}_{i} )}{ Γ ( {\sum }_{i = 1}^{K} {n}_{m , ( \cdot )}^{ i} + {α}_{i} )} {\prod }_{i = 1}^{K} \frac{Γ ( {n}_{( \cdot ) , v}^{ i} + {β}_{v} )}{Γ ( {\sum }_{r = 1}^{V} {n}_{( \cdot ) , r}^{ i} + {β}_{r} )} ∝ \frac{{\prod }_{i = 1}^{K} Γ ( {n}_{m , ( \cdot )}^{ i} + {α}_{i} )}{ Γ ( {\sum }_{i = 1}^{K} {n}_{m , ( \cdot )}^{ i} + {α}_{i} )} {\prod }_{i = 1}^{K} \frac{Γ ( {n}_{( \cdot ) , v}^{ i} + {β}_{v} )}{Γ ( {\sum }_{r = 1}^{V} {n}_{( \cdot ) , r}^{ i} + {β}_{r} )} ∝ {\prod }_{i = 1}^{K} Γ ( {n}_{m , ( \cdot )}^{ i} + {α}_{i} ) {\prod }_{i = 1}^{K} \frac{Γ ( {n}_{( \cdot ) , v}^{ i} + {β}_{v} )}{Γ ( {\sum }_{r = 1}^{V} {n}_{( \cdot ) , r}^{ i} + {β}_{r} )} .$$

Finally, let n^{i,-(m,n)}_{j,r} be the same meaning as nⁱ_{j,r} but with the Z_{(m,n)} excluded. The above equation can be further simplified leveraging the property of gamma function. We first split the summation and then merge it back to obtain a k-independent summation, which could be dropped:

$$∝ {\prod }_{i \neq k} Γ ( {n}_{m , ( \cdot )}^{ i , - ( m , n )} + {α}_{i} ) {\prod }_{i \neq k} \frac{Γ ( {n}_{( \cdot ) , v}^{ i , - ( m , n )} + {β}_{v} )}{Γ ( {\sum }_{r = 1}^{V} {n}_{( \cdot ) , r}^{ i , - ( m , n )} + {β}_{r} )} \times Γ ( {n}_{m , ( \cdot )}^{ k , - ( m , n )} + {α}_{k} + 1 ) \frac{Γ ( {n}_{( \cdot ) , v}^{k , - ( m , n )} + {β}_{v} + 1 )}{Γ ( ( {\sum }_{r = 1}^{V} {n}_{( \cdot ) , r}^{ k , - ( m , n )} + {β}_{r} ) + 1 )} = {\prod }_{i \neq k} Γ ( {n}_{m , ( \cdot )}^{ i , - ( m , n )} + {α}_{i} ) {\prod }_{i \neq k} \frac{Γ ( {n}_{( \cdot ) , v}^{ i , - ( m , n )} + {β}_{v} )}{Γ ( {\sum }_{r = 1}^{V} {n}_{( \cdot ) , r}^{ i , - ( m , n )} + {β}_{r} )} \times Γ ( {n}_{m , ( \cdot )}^{ k , - ( m , n )} + {α}_{k} ) \frac{Γ ( {n}_{( \cdot ) , v}^{k , - ( m , n )} + {β}_{v} )}{Γ ( {\sum }_{r = 1}^{V} {n}_{( \cdot ) , r}^{ k , - ( m , n )} + {β}_{r} )} \times ( {n}_{m , ( \cdot )}^{ k , - ( m , n )} + {α}_{k} ) \frac{{n}_{( \cdot ) , v}^{k , - ( m , n )} + {β}_{v}}{{\sum }_{r = 1}^{V} {n}_{( \cdot ) , r}^{ k , - ( m , n )} + {β}_{r}} = {\prod }_{i} Γ ( {n}_{m , ( \cdot )}^{ i , - ( m , n )} + {α}_{i} ) {\prod }_{i} \frac{Γ ( {n}_{( \cdot ) , v}^{ i , - ( m , n )} + {β}_{v} )}{Γ ( {\sum }_{r = 1}^{V} {n}_{( \cdot ) , r}^{ i , - ( m , n )} + {β}_{r} )} \times ( {n}_{m , ( \cdot )}^{ k , - ( m , n )} + {α}_{k} ) \frac{{n}_{( \cdot ) , v}^{k , - ( m , n )} + {β}_{v}}{{\sum }_{r = 1}^{V} {n}_{( \cdot ) , r}^{ k , - ( m , n )} + {β}_{r}} ∝ ( {n}_{m , ( \cdot )}^{ k , - ( m , n )} + {α}_{k} ) \frac{{n}_{( \cdot ) , v}^{ k , - ( m , n )} + {β}_{v}}{{\sum }_{r = 1}^{V} {n}_{( \cdot ) , r}^{ k , - ( m , n )} + {β}_{r}} .$$

The feature vector generator 308 then utilizes the topic model to extract a set of topic model features for each snippet. During training, this means that the set of topic model features is extracted from each of the training snippets. During runtime, this means that the set of topic model features is extracted from each of the candidate snippets. In some example embodiments, the feature vector includes every topic in the topic model, along with a calculation for the similarity of the snippet to the topic for each of those topics, calculated using the terms and weights in the topic model as it relates to the actual text of the snippet. Thus, for example, for a snippet having terms listed in the topic model as being highly relevant to the topic of “computer programming,” but not being highly relevant to the topic of “real estate”, the feature vector will include a higher calculated score for the computer programming field in the vector than for the real estate field in the vector. The feature vector generator 308 may also extract additional features, including, for example, textual features and categorical features. Textual features include features such as term frequency or other features related to the text of the snippet. Categorical features include features such as assigned category for the snippet, as defined by, for example, keywords that indicate a particular category.

Example features include job ID, company ID, normalized position of sentences/sections, topic model probability distribution across N topics, and term frequency-inverse document frequency (TF-IDF) weight.

It should be noted that the training stage can be performed in an off line manner. A candidate snippet relevance score calculator 316 then uses the potential snippet relevance score model 312 to generate a relevance score for each of a number of different candidate snippets generated by the internal job posting retriever 300. For efficiency and scalability reasons, in some example embodiments this stage may be performed in an off line fashion and a large number of relevant snippets can be scored for each job posting, for example, when the job posting is first indexed as part of an indexing pipeline or whenever it is updated by the job poster. The set of relevant snippets for each document can be stored using an indexing system such as Lucene or using a key-value store (herein the key is the job posting identification) for efficient retrieval during runtime.

A snippet ranking component 318 then ranks the snippets that have been scored by the candidate snippet relevance score calculator 316. This ranking is based at least partially on the candidate snippet relevance scores for each snippet, but also can be based on a search query and/or member context provided at runtime when a member performs a search. The candidate snippet relevance scores may be boosted based on the extent of overlap with the search query and/or member context (such as skills or experience). The algorithm for reranking the snippets is described below.

The algorithm for reranking takes as input the desired number of snippets (k), a retrieval system that contains the pre-generated set of relevant snippets for each document, the member context, m, and/or the search query, q. In this algorithm, the retrieval system is queried to obtain the set of relevant snippets C (along with corresponding relevance scores, s(c,d) for each snippet c) for document d. Then a boosted relevance score is computed as s(c)=h(s(c,d), s(c,m), s(c,q), where h(x,y,z) is a monotonically increasing function in x, y, and z. For example, h(x,y,z)=xyz, or h(x,y,z)=x log(y) log(z). Here, s(c,m) denotes the score of snippet c with respect to the member context m and s(c,q) the score of snippet c with respect to query q. These scores can be computed based on textual overlap, or themselves be obtained using a machine learning algorithm (for example, to determine the relative weighting between the overlap of the snippet with different fields in the member context).

Then, the top k snippets based on the score s( )are returned.

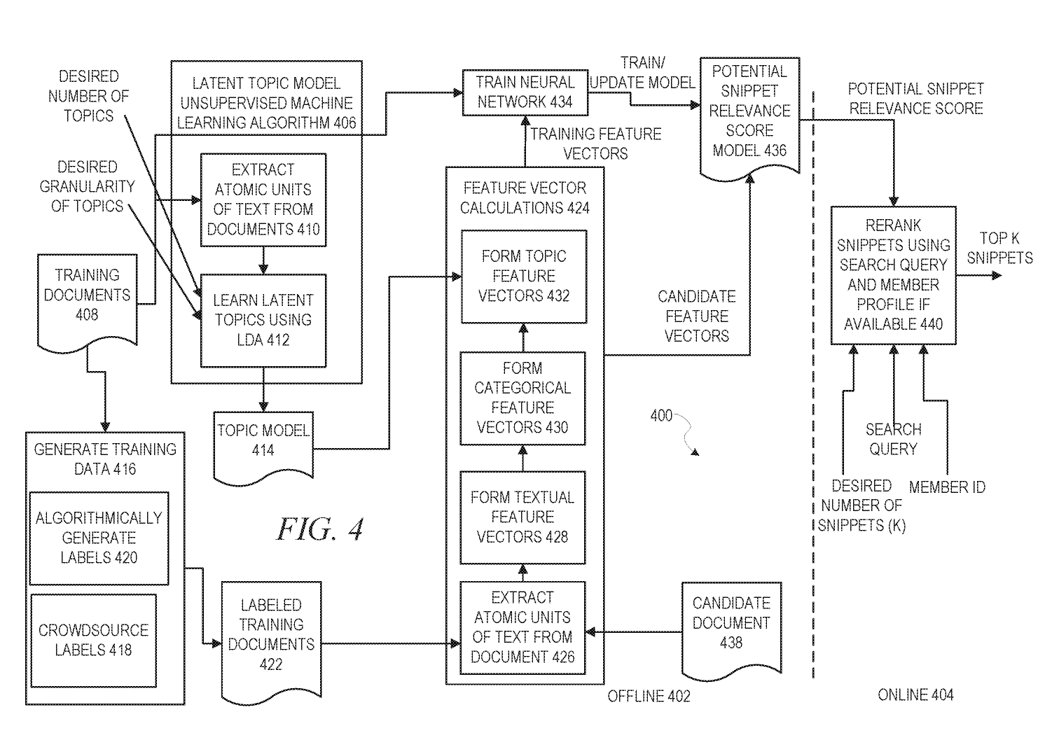

FIG. 4 is a diagram illustrating a process flow of a method 400 of automatically generating text snippets in accordance with an example embodiment. The method 400 may include an off line portion 402 and an on line portion 404. The off line portion 402 may execute prior to a particular query time, whereas the on line portion 404 may execute at or after query time, allowing the system to take into account the query itself as well as the member making the query in reranking snippets.

A latent topic model unsupervised machine learning algorithm 406 takes training documents 408 as input and then performs extraction 410 of atomic units of text from the documents. These extracted atomic units are then passed to an process 412 to learn latent topics using LDA, which also takes as input the number of desired topics and the desired granularity of topics. The LDA process 412 was described in detail earlier and will not be repeated here. The result is a topic model 414 having, for example, a list of topics with corresponding relevant terms and weights, as described earlier.

The training documents 408 are also passed to a generate training data process 416, which acts to generate training data from the training documents 408 by either (or both of) crowd sourcing labels 418 or algorithmically generating labels 420. These were described in more detail earlier and this description will not be repeated here. Regardless of the mechanism by which the training data is generated, the result is labeled training documents 422. These labeled training documents 422 may then be passed to a feature vector calculations process 424. Specifically, an extraction process 426 extracts atomic units of text from each of the labeled training documents 422. Various training feature vectors are then formed for each extracted atomic unit of text. A process 428 forms textual feature vectors by, for example, performing various calculations (e.g., TF-LDF) on textual elements such as terms in each atomic unit of text. Categorical features are formed in a process 430 by, for example, performing various categorizations of the atomic units of text (e.g., classifying key terms into categories). Topic feature vectors are formed in a process 432 by using the topic model 414 to generate relevancy scores for each atomic unit of text for each topic in the topic model 414, based on which terms in each atomic unit of text match terms in each topic in the topic model 41.4

The result during training from the feature vector calculations process 424 is a set of training feature vectors. These training feature vectors are then used to train a neural network 434, which acts to train, or update, a potential snippet relevance score model 436, which is designed to calculate a relevance scope for each potential candidate snippet.

Once training is complete, one or more candidate documents 438 may have their own potential snippets evaluated and assigned a potential snippet relevance score. This process may be performed off line, such as when the one or more candidate documents 438 are first uploaded to a database, or periodically, at some point before a query is performed on the one or more candidate documents 438. Whatever the desired time, the candidate document 438 may be passed to the feature vector calculations process 424, which acts to extract atomic units of text from the document (process 426), and then form textual feature vectors (process 428), form categorical feature vectors (process 430), and form topic feature vectors (process 432) from the atomic units of text extracted from the candidate document 438. The result is a set of candidate feature vectors, which may be passed to the potential snippet relevance score model 436 to generate a potential snippet relevance score for each of the potential snippets in the candidate document 438.

While the potential snippet relevance scores for each of the potential snippets can be used to recommend a snippet for each candidate document 438 in an off line manner by, for example, ranking the potential snippet relevancy scores and selecting the snippet having the highest potential relevance score, in an example embodiment, in the on line portion 404 the potential snippets are reranked in a process 440 using information only available during or after the time of a query. This information includes the search query itself (which may include any filters selected in a browsing mode) and an identification of the member performing the search query. This reranking process 440 may also take as input a desired number of snippets (k), although this value may be set by, for example, an administrator rather than by the member performing the search query. The result is that the potential snippets are reranked based on the combination of each of their potential snippet relevancy scores, the relevancy of each potential snippet to the search query being performed, and the relevancy of the potential snippet to the member performing the search query (based on information in the member's corresponding member profile). In example embodiments, it is not necessary that all these variables be used There may be cases where, for example, the member identification or the search query are not available, such as where the member is not actually performing an explicit search query but instead merely browsing the site, or where the member performs a search without logging in. In such cases, the reranking process 440 can use whatever information is available to it, to produce a list of the top k snippets, from which one or more snippets may be displayed to the member.

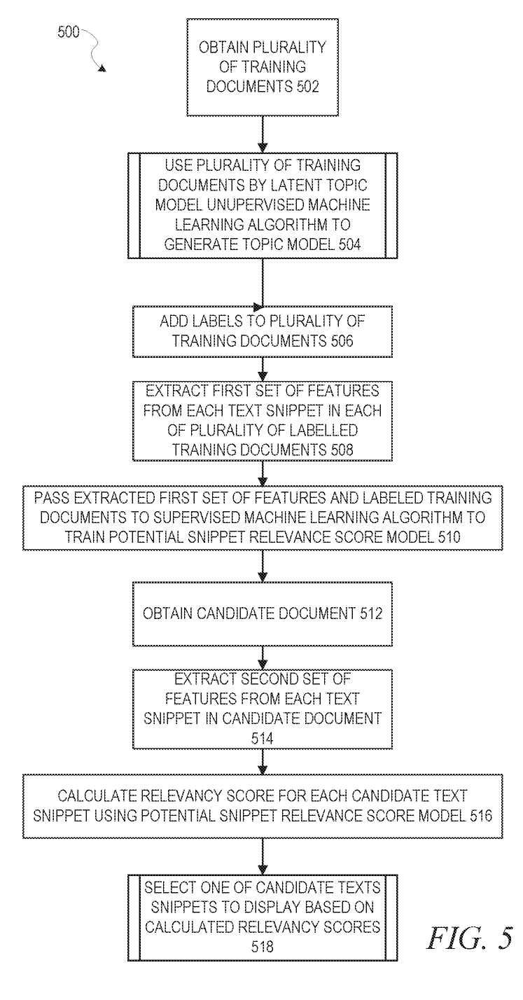

FIG. 5 is a flow diagram illustrating a method 500 for selecting text snippets to display on a computer display, in accordance with an example embodiment. At operation 502, a plurality of training documents are obtained. At operation 504, the plurality of training documents are used by a latent topic model unsupervised machine learning algorithm to generate a topic model based on the plurality of training documents, a desired granularity of topics, and a desired number of topics.

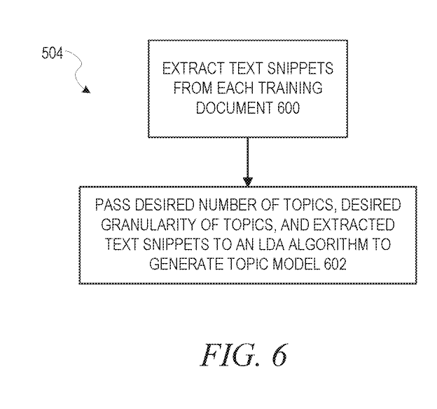

FIG. 6 is a flow diagram illustrating operation 504 in more detail, in accordance with an example embodiment. At operation 600, text snippets are extracted from each training document. At operation 602, a desired number of topics, desired granularity of topics, and the extracted text snippets are passed to an LDA algorithm to generate a topic model. In an example embodiment, the topic model contains a list of a plurality of different topics, and, for each of the plurality of different topics, a list of terms relevant to the corresponding topic and a weight indicating the relevancy of each term to the corresponding topic.

Referring back to FIG. 5, at operation 506, labels are added to the plurality of training documents. These may be added either based on crowd sourcing, or on algorithmically generating labels for each of the training documents based on whether or not each of the plurality of labelled training documents contains one or more preset phrases.

At operation 508, a first set of features are extracted from each text snippet in each of the plurality of labelled training documents. At operation 510, the extracted first set of features and the plurality of labelled training documents are passed to a supervised machine learning algorithm to train a potential snippet relevance score model.

At operation 512, candidate document is obtained. At operation 514, a second set of features is extracted from each of a plurality of candidate text snippets in the candidate document. In an example embodiment, the first set of features is identical to the second set of features. At operation 516, a relevancy score is calculated for each of the plurality of candidate text snippets using the potential snippet relevance score model. At operation 518, one of the plurality of candidate text snippets is selected to display based on the calculated relevancy scores.

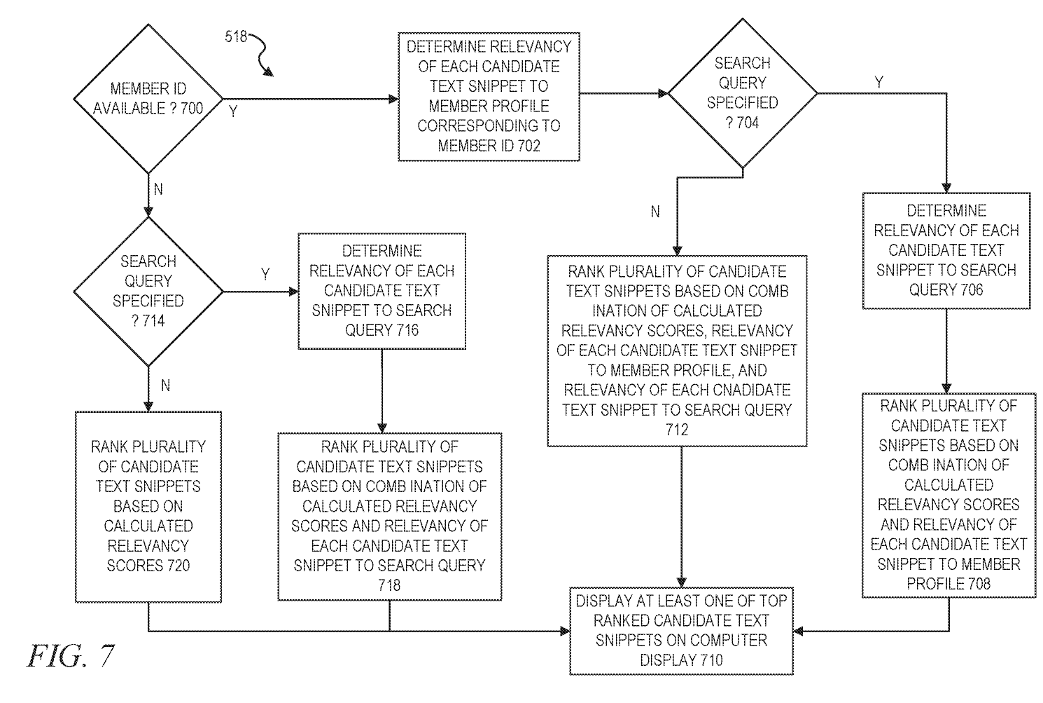

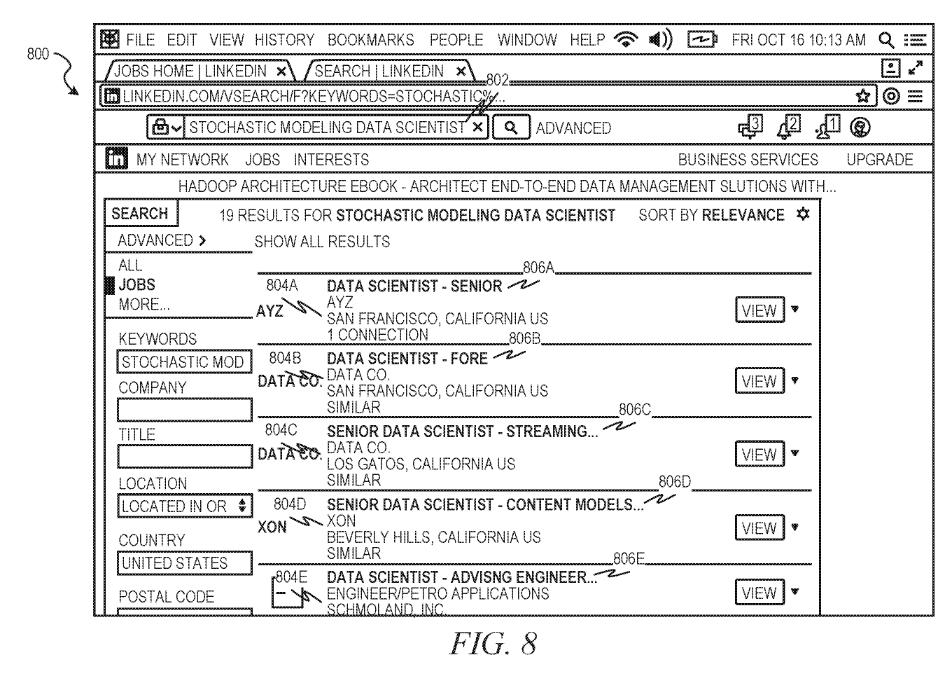

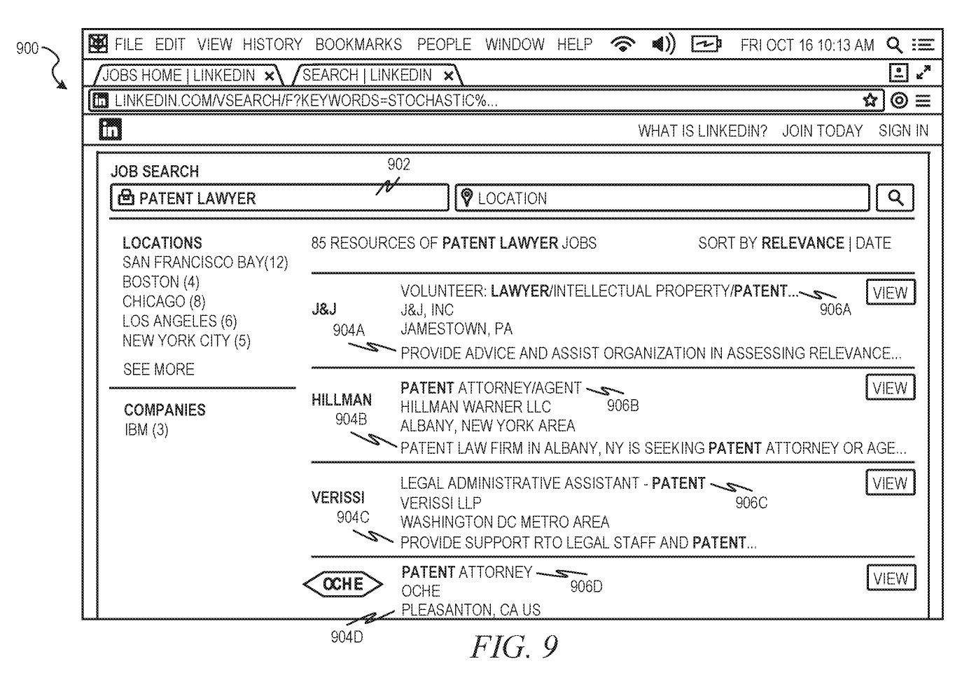

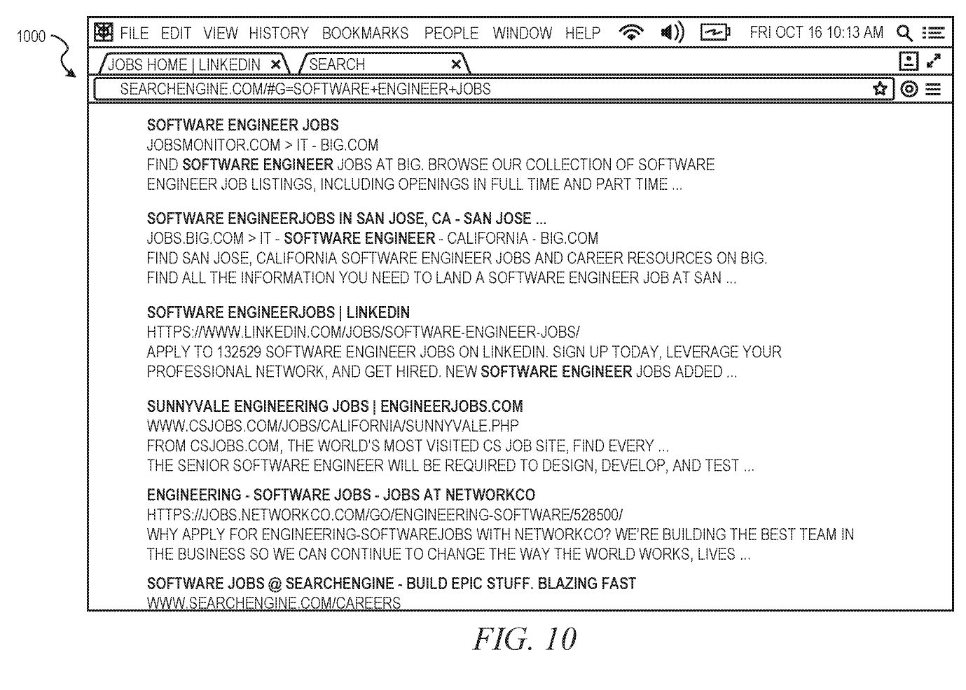

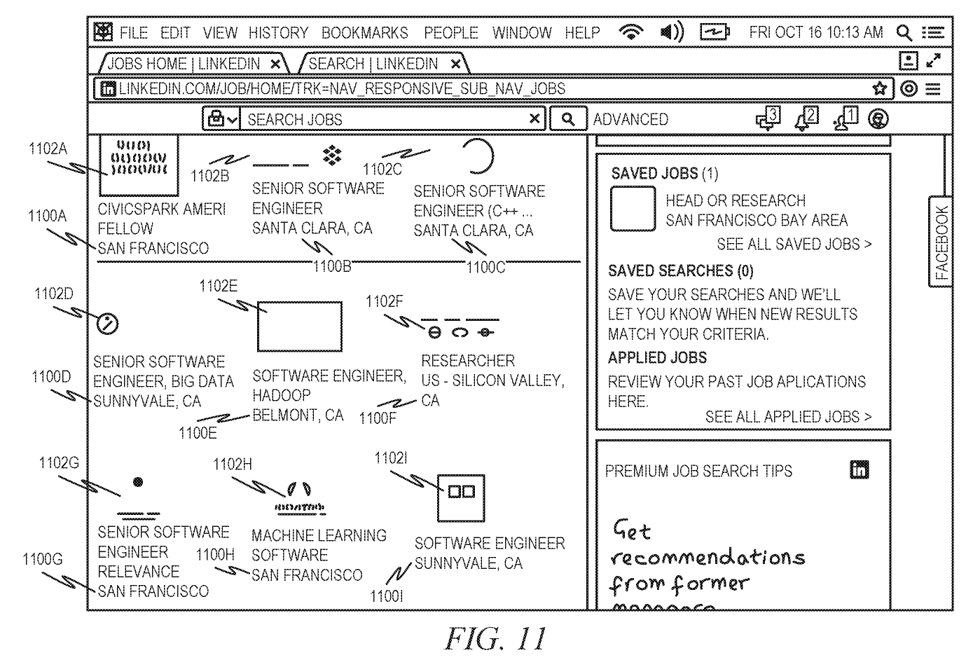

FIG. 7 is a flow diagram illustrating operation 518 in more detail, in accordance with an example embodiment. At operation 700, it is determined if a. member identification is available for a current session. In an example embodiment, if a member has logged into a social networking service, then the member identification is available; however, in some example embodiments, there may be alternative ways to identify a member involved in the current session. If the member identification is available, then at operation 702, a relevancy of each candidate text snippet to a member profile corresponding to the member identification is determined. Then at operation 704, it is determined if a search query has been specified by the member. This search query may take many forms. In some example embodiments, the search query may be keywords or phrases explicitly typed by the member in a search box. In other example embodiments, the search query can be inferred based on one or more filters selected by the member and/or other browsing actions. Nevertheless, if a search query has been specified by the member, then at operation 706, relevancy of each candidate text snippet to the search query is determined. Then, at operation 708, the plurality of candidate text snippets is ranked based on a combination of the calculated relevancy scores, relevancy of each candidate text snippet to a member profile corresponding to a member performing a search query, and relevancy of each candidate text snippet to the search query. At operation 710, at least one of the top ranked candidate text snippets is displayed on the computer display.

If it is determined at operation 704 that no search query has been specified by the member, then at operation 712 the plurality of candidate text snippets is ranked based on a combination of the calculated relevancy scores and the relevancy of each candidate text snippet to a member profile corresponding to a member performing a search query. The process of operation 518 then proceeds to operation 710.

If it is determined at operation 700 that there is no member identification available for the current session, then at operation 714 it is determined if a search query has been specified by the member. If a search query has been specified by the member, then at operation 716, relevancy of each candidate text snippet to the search query is determined. Then at operation 718, the plurality of candidate text snippets is ranked based on a combination of the calculated relevancy scores and relevancy of each candidate text snippet to the search query. The process of operation 518 then proceeds to operation 710.

If it is determined at operation 714 that no search query has been specified by the member, then at operation 720 the plurality of candidate text snippets is ranked based on the calculated relevancy scores. The operation 518 then proceeds to operation 718 and then to operation 710.

FIGS. 8-11 represent exemplary user interfaces for receiving information relevant to a job search and returning job snippets, in accordance with an example embodiment. Referring first to FIG. 8, here a user interface 800 is provided allowing a member to enter a search query 802. Additionally, while not explicitly depicted, the user interface 800 is only presented to members who have logged in. Thus, once the search query 802 is input by the member, the user interface 800 has information about an identification of the member as well as information about the search query 802 itself. Both of these pieces of information may be used in operation 518 of FIG. 5 to determine which job snippets 804A-804E to include when job posting results 806A-806E are returned to the member.

Referring now to FIG. 9, here a user interface 900 is provided allowing a non-member (or at least a user who has not logged in) to enter a search query 902. Thus, once the search query 902 is input by the user, the user interface 900 has information about the search query 902 itself but does not have an identification of the user. As such, operation 518 of FIG. 5 uses the information about the search query 902 but not an identification of a member to determine which job snippets 904A-904D to include when job posting results 906A-906D are returned to the member.

Referring now to FIG. 10, here a general search engine user interface 1000 is provided allowing a non-member to enter a search query. The general search engine user interface 1000 is distinct from a search query user interface used for members who log in to a social networking service. For example, the general search engine user interface 1000 is designed to retrieve results for general search queries, whether related to the social networking service (e.g., jobs, people, profiles) or not. Here, the user has already entered a search query for “software engineer jobs.” Notably, the way general search engines typically work is to index results for various searches before the searches are performed, and as such the results for “software engineer jobs” have already been indexed before the user enters the search query. As part of that previous indexing, the social networking service could elect to create snippets in accordance with the embodiments described above with respect to FIGS. 4-7, using sample search queries to generate such snippets to populate pages for indexing by the general search engine. Thus, the search engine service can prepopulate the snippets for jobs that are the result of general search engine queries. This may be done in a similar manner to that illustrated in FIG. 9, as in both cases the system has at its disposal a search query (whether user-entered or pre-assumed) but does not have an identification of the member/user who will be viewing the job postings as a result of the search query.

Referring now to FIG. 11, here a member has logged in to a social networking service but has not performed a search query. Rather, the social networking service wishes to provide job recommendations to the member without the member expressly requesting them. In such a case, the system has at its disposal the identification of the member but does not have a search query. As such, operation 518 of FIG. 5 uses an identification of a member but not information about the search query to determine which job snippets 1100A-1100I to include when job posting results 1102A-1102I are returned to the member.

It should be noted that while the above description illustrates concepts related to job snippets, the processes described above can be extended to types of snippets other than job snippets. For example, snippets about members can be provided in a similar manner, with a universal concept graph being limited to the members domain instead of the jobs domain. Universities, companies, news articles, etc. are additional entities about which snippets can be obtained in a similar fashion.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwire), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications, and so forth described in conjunction with FIGS. 1-11. are implemented in some embodiments in the context of a machine and an associated software architecture. The sections below describe representative software architecture(s) and machine (e.g., hardware) architecture(s that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things,” while yet another combination produces a server computer for use within a cloud computing architecture. Not all combinations of such software and hardware architectures are presented here, as those of skill in the art can readily understand how to implement the inventive subject matter in different contexts from the disclosure contained herein.

### Software Architecture

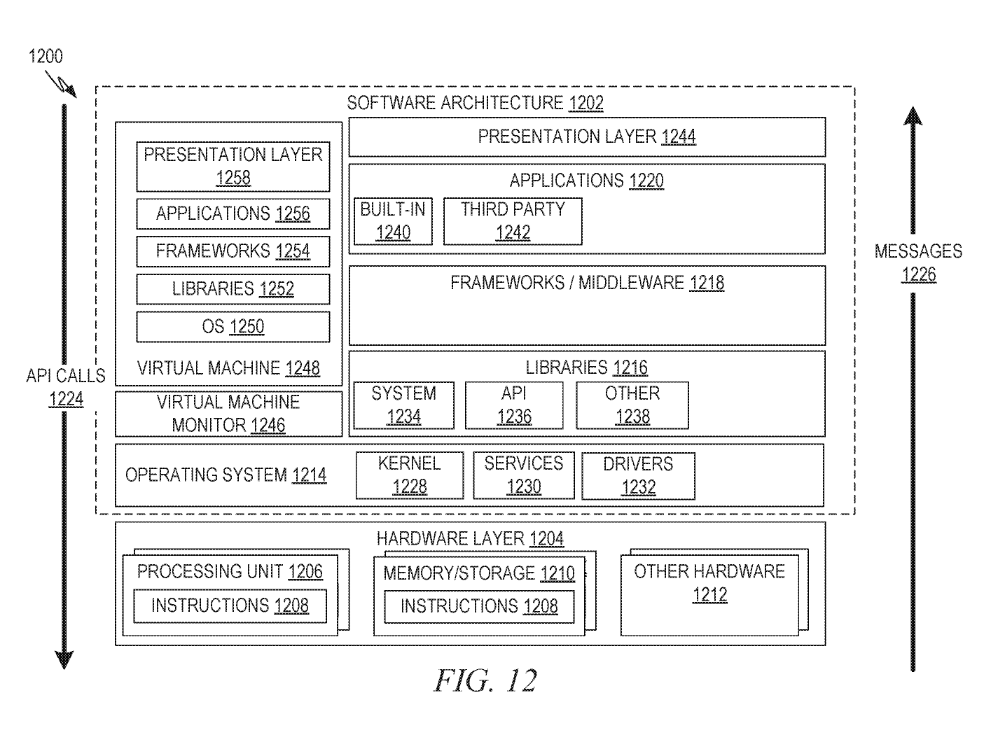

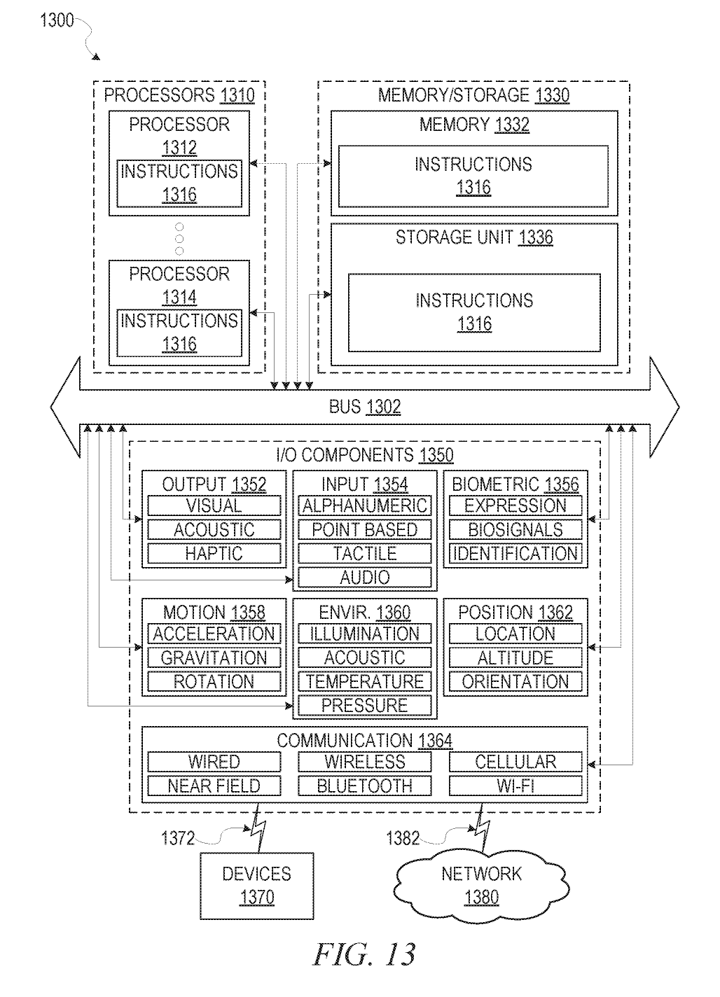

FIG. 12 is a block diagram 1200 illustrating a representative software architecture 1202, which may be used in conjunction with various hardware architectures herein described. FIG. 12 is merely a non-limiting example of a software architecture 1202, and it will be appreciated that many other architectures may be implemented to facilitate the functionality described herein. The software architecture 1202 may be executing on hardware such as a machine 1300 of FIG. 13 that includes, among other things, processors 1310, memory/storage 1330, and 110 components 1350. A representative hardware layer 1204 is illustrated in FIG. 12 and can represent, for example, the machine 1300 of FIG. 13. The representative hardware layer 1204 comprises one or more processing units 1206 having associated executable instructions 1208. The executable instructions 1208 represent the executable instructions of the software architecture 1202, including implementation of the methods, modules, and so forth of FIGS. 1-11. The hardware layer 1204 also includes memory and/or storage modules 1210, which also have the executable instructions 1208. The hardware layer 1204 may also comprise other hardware 1212, which represents any other hardware of the hardware layer 1204, such as the other hardware illustrated as part of the machine 1300.

In the example architecture of FIG. 12, the software architecture 1202 may be conceptualized as a stack of layers where each layer provides particular functionality. For example, the software architecture 1202 may include layers such as an operating system 1214, libraries 1216, frameworks/middleware 1218, applications 1220, and a presentation layer 1244. Operationally, the applications 1220 and/or other components within the layers may invoke API calls 1224 through the software stack and receive responses, returned values, and so forth, illustrated as messages 1226, in response to the API calls 1224. The layers illustrated are representative in nature and not all software architectures have all layers. For example, some mobile or special purpose operating systems may not provide a layer of frameworks/middleware 1218, while others may provide such a layer. Other software architectures may include additional or different layers.

The operating system 1214 may manage hardware resources and provide common services. The operating system 1214 may include, for example, a kernel 1228, services 1230, and drivers 1232. The kernel 1228 may act as an abstraction layer between the hardware and the other software layers. For example, the kernel 1228 may be responsible for memory management, processor management (e.g., scheduling), component management, networking, security settings, and so on. The services 1230 may provide other common services for the other software layers. The drivers 1232 may be responsible for controlling or interfacing with the underlying hardware. For instance, the drivers 1232 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1216 may provide a common infrastructure that may be utilized by the applications 1220 and/or other components and/or layers. The libraries 1216 typically provide functionality that allows other software modules to perform tasks in an easier fashion than by interfacing directly with the underlying operating system 1214 functionality (e.g., kernel 1228, services 1230, and/or drivers 1232). The libraries 1216 may include system 1234 libraries (e.g., C standard library) that may provide functions such as memory allocation functions, string manipulation functions, mathematic functions, and the like. In addition, the libraries 1216 may include API 1236 libraries such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 1216 may also include a wide variety of other 1238 libraries to provide many other APIs to the applications 1220 and other software components/modules.

The frameworks 1218 (also sometimes referred to as middleware) may provide a higher-level common infrastructure that may be utilized by the applications 1220 and/or other software components/modules. For example, the frameworks 1218 may provide various graphic user interface (GUI) functions, high-level resource management, high-level location services, and so forth. The frameworks 1218 may provide a broad spectrum of other APIs that may be utilized by the applications 1220 and/or other software components/modules, some of which may be specific to a particular operating system or platform.

The applications 1220 include built-in applications 1240 and/or third party applications 1242. Examples of representative built-in applications 1240 may include, but are not limited to, a contacts application, a browser application, a book reader application, a location application, a media application, a messaging application, and/or a game application. The third party applications 1242 may include any of the built-in applications 1240 as well as a broad assortment of other applications. In a specific example, the third party application 1242 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 1242 may invoke the API calls 1224 provided by the mobile operating system, such as the operating system 1214, to facilitate functionality described herein,

The applications 1220 may utilize built-in operating system 1214 functions (e.g., kernel 1228, services 1230, and/or drivers 1232), libraries 1216 (e.g., system 1234, API 1236, and other libraries 1238), and frameworks/middleware 1218 to create user interfaces to interact with users of the system. Alternatively, or additionally, in some systems, interactions with a user may occur through a presentation layer, such as the presentation layer 1244. In these systems, the application/module “logic” can be separated from the aspects of the application/module that interact with a user.

Some software architectures utilize virtual machines. In the example of FIG. 12, this is illustrated by a virtual machine 1248. A virtual machine creates a software environment where applications/modules can execute as if they were executing on a hardware machine (such as the machine 1300 of FIG. 13, for example). A virtual machine is hosted by a host operating system (e.g., operating system 1214 in FIG. 12) and typically, although not always, has a virtual machine monitor 1246, which manages the operation of the virtual machine 1248 as well as the interface with the host operating system (e.g., operating system 1214) A software architecture executes within the virtual machine 1248, such as an operating system 1250, libraries 1252, frameworks/middleware 1254, applications 1256, and/or a presentation layer 1258. These layers of software architecture executing within the virtual machine 1248 can be the same as corresponding layers previously described or may be different.

### Example Machine Architecture and Machine-readable Medium

FIG. 13 is a block diagram illustrating components of a machine 1300, according to some example embodiments, able to read instructions from a machine-readable medium (e.g., a machine-readable storage medium) and perform any one or more of the methodologies discussed herein. Specifically, FIG. 13 shows a diagrammatic representation of the machine 1300 in the example form of a computer system, within which instructions 1316 (e.g., software, a program, an application, an applet, an app, or other executable code) for causing the machine 1300 to perform any one or more of the methodologies discussed herein may be executed. The instructions 1316 transform the general, non-programmed machine into a particular machine programmed to carry out the described and illustrated functions in the manner described. In alternative embodiments, the machine 1300 operates as a standalone device or may be coupled (e.g., networked) to other machines. In a networked deployment, the machine 1300 may operate in the capacity of a server machine or a client machine in a server-client network environment, or as a peer machine in a peer-to-peer (or distributed) network environment. The machine 1300 may comprise, but not be limited to, a server computer, a client computer, a PC, a tablet computer, a lap top computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1316, sequentially or otherwise, that specify actions to be taken by the machine 1300. Further, while only a single machine 1300 is illustrated, the term “machine” shall also be taken to include a collection of machines 1300 that individually or jointly execute the instructions 1316 to perform any one or more of the methodologies discussed herein.

The machine 1300 may include processors 1310, memory/storage 1330, and I/O components 1350, which may be configured to communicate with each other such as via a bus 1302. In an example embodiment, the processors 1310 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RTIC), another processor, or any suitable combination thereof) may include, for example, a processor 1312 and a processor 1314 that may execute the instructions 1316. The term “processor” is intended to include multi-core processors that may comprise two or more independent processors (sometimes referred to as “cores”) that may execute instructions contemporaneously. Although FIG. 13 shows multiple processors 1310, the machine 1300 may include a single processor with a single core, a single processor with multiple cores (e.g., a multi-core processor), multiple processors with a single core, multiple processors with multiples cores, or any combination thereof.

The memory/storage 1330 may include a memory 1332, such as a main memory, or other memory storage, and a storage unit 1336, both accessible to the processors 1310, such as via the bus 1302. The storage unit 1336 and memory 1332 store the instructions 1316 embodying any one or more of the methodologies or functions described herein. The instructions 1316 may also reside, completely or partially, within the memory 1332, within the storage unit 1336, within at least one of the processors 1310 (e.g., within the processor's cache memory), or any suitable combination thereof, during execution thereof by the machine 1300. Accordingly, the memory 1332, the storage unit 1336, and the memory of the processors 1310 are examples of machine-readable media.

As used herein, “machine-readable medium” means a device able to store instructions and data temporarily or permanently and may include, but is not limited to, random-access memory (RAM), read-only memory (ROM), butler memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 1316. The term “machine-readable medium” shall also be taken to include any medium, or combination of multiple media, that is capable of storing instructions 1316) for execution by a machine (e.g., machine 1300), such that the instructions, when executed by one or more processors of the machine (e.g., processors 1310), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1350 may include a wide variety of components to receive input, provide output, produce output, transmit information, exchange information, capture measurements, and so on. The specific I/O components 1350 that are included in a particular machine will depend on the type of machine. For example, portable machines such as mobile phones will likely include a touch input device or other such input mechanisms, while a headless server machine will likely not include such a touch input device. It will be appreciated that the I/O components 1350 may include many other components that are not shown in FIG. 13. The I/O components 1350 are grouped according to functionality merely for simplifying the following discussion and the grouping is in no way limiting. In various example embodiments, the I/O components 1350 may include output components 1352 and input components 1354. The output components 1352 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1354 may include alphanumeric input components (e.g., a keyboard, a touch screen configured to receive alphanumeric input, a photo-optical keyboard, or other alphanumeric input components), point based input components (e.g., a mouse, a touch pad, a track ball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1350 may include biometric components 1356, motion components 1358, environmental components 1360, or position components 1362, among a wide array of other components. For example, the biometric components 1356 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1358 may include acceleration sensor components (e.g., accelerometer), gravitation sensor components, rotation sensor components (e.g., gyroscope), and so forth. The environmental components 1360 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1362 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1350 may include communication components 1364 operable to couple the machine 1300 to a network 1380 or devices 1370 via a coupling 1382 and a coupling 1372, respectively. For example, the communication components 1364 may include a network interface component or other suitable device to interface with the network 1380. In further examples, the communication components 1364 may include wired communication components, wireless communication components, cellular communication components, Near Field Communication (NEC) components, Bluetooth® components (e.g., Bluetooth® Low Energy), Wi-Fi® components, and other communication components to provide communication via other modalities. The devices 1370 may be another machine or any of a wide variety of peripheral devices (e.g., a peripheral device coupled via a UnivUSB).

Moreover, the communication components 1364 may detect identifiers or include components operable to detect identifiers. For example, the communication components 1364 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1364, such as location via Internet Protocol (IP) geolocation, location via Wi-Fi® signal triangulation, location via detecting an NFC beacon signal that may indicate a particular location, and so forth.

### Transmission Medium

In various example embodiments, one or more portions of the network 1380 may be an ad hoc network, an intranet, an extranet, a virtual private network (VPN), a local area network (LAN), a wireless LAN (WLAN), a WAN, a wireless WAN (WW AN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1380 or a portion of the network 1380 may include a wireless or cellular network and the coupling 1382 may be a Code Division Multiple Access (CDMA) connection, a Global System for Mobile communications (GSM) connection, or another type of cellular or wireless coupling. In this example, the coupling 1382 may implement any of a variety of types of data transfer technology, such as Single Carrier Radio Transmission Technology (1×RTT), Evolution-Data Optimized (RVDO) technology, General Packet Radio Service (GPRS) technology, Enhanced Data rates for GSM Evolution (EDGE) technology, third Generation Partnership Project (3GPP) including 3G. fourth generation wireless (4G) networks, Universal Mobile Telecommunications System (UMTS), High Speed Packet Access (HSPA), Worldwide Interoperability for Microwave Access (Wi MAX), Long Term Evolution (LTE) standard, others defined by various standard-setting organizations, other long range protocols, or other data transfer technology.

The instructions 1316 may be transmitted or received over the network 1380 using a transmission medium via a network interface device (e.g., a network interface component included in the communication components 1364) and utilizing any one of a number of well-known transfer protocols (e.g., HTTP). Similarly, the instructions 1316 may be transmitted or received using a transmission medium via the coupling 1372 (e.g., a peer-to-peer coupling) to the devices 1370. The term “transmission medium” shall be taken to include any intangible medium that is capable of storing, encoding, or carrying the instructions 1316 for execution by the machine 1300, and includes digital or analog communications signals or other intangible media to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A computer-implemented method for selecting text. snippets to display on a computer display, the method comprising:
obtaining a plurality of labeled training documents, each labeled training document containing a plurality of text snippets;
extracting a first set of features from each text snippet in each of the plurality, of labeled training documents;
passing the extracted first set of features and the plurality of labeled training documents to a supervised machine learning algorithm to train a potential snippet relevance score model;
extracting a second set of features from each of a plurality of candidate text snippets in a candidate document;
calculating a relevancy score for each of the plurality of candidate text snippets using the potential snippet relevance score model; and
selecting one of the plurality of candidate text snippets to display based on the calculated relevancy scores.

2. The method of claim 1, wherein the selecting includes:
ranking the plurality of candidate text snippets based on a combination of the calculated relevancy scores, relevancy of each candidate text snippet to a member profile corresponding to a member performing a search query, and relevancy of each candidate text snippet to the search query.

3. The method of claim 1, further comprising:
passing the labeled training documents to a latent topic model unsupervised machine learning algorithm to generate a topic model based on the labeled training documents, a desired granularity of topics, and a desired number of topics.

4. The method of claim 3, wherein the topic model includes a list of a plurality of different topics, and, for each of the plurality of different topics, a list of terms relevant to the corresponding topic and a weight indicating the relevancy of each term to the corresponding topic.

5. The method of claim 4, wherein the extracting the first set of features includes extracting a topic feature from each text snippet in each of the plurality of labeled training documents based on the topic model.

6. The method of claim 4, wherein the extracting the second set of features includes extracting a topic feature from each of the plurality of candidate text snippets in a candidate document based on the topic model.

7. The method of claim 1, wherein the obtaining a plurality of labeled training documents includes obtaining training documents and algorithmically generating labels for each of the training documents based on whether or not each of the plurality of labeled training documents contain one or more preset phrases.

8. A system comprising:
a computer-readable medium having instructions stored thereon, which, when executed by a processor, cause the system to perform operations comprising:
obtaining a plurality of labeled training documents, each labeled training document containing a plurality of text snippets;
extracting a first set of features from each text snippet in each of the plurality of labeled training documents;
passing the extracted first set of features and the plurality of labeled training documents to a supervised machine learning algorithm to train a potential snippet relevance score model;
extracting a second set of features from each of a plurality of candidate text snippets in a candidate document;
calculating a relevancy score for each of the plurality of candidate text snippets using the potential snippet relevance score model; and
selecting one of the plurality of candidate text snippets to display based on the calculated relevancy scores.

9. The method of claim 8, wherein the selecting includes:
ranking the plurality of candidate text snippets based on a combination of the calculated relevancy scores, relevancy of each candidate text snippet to a member profile corresponding to a member performing a search query, and relevancy of each candidate text snippet to the search query.

10. The system of claim 8, further comprising:
passing the labeled training documents to a latent topic model unsupervised machine learning algorithm to generate a topic model based on the labeled training documents, a desired granularity of topics, and a desired number of topics.

11. The system of claim 10, wherein the topic model includes a list of a plurality of different topics, and, for each of the plurality of different topics, a list of terms relevant to the corresponding topic and a weight indicating the relevancy of each term to the corresponding topic.

12. The system of claim 11, wherein the extracting the first set of features includes extracting a topic feature from each text snippet in each of the plurality of labeled training documents based on the topic model.

13. The system of claim 11, wherein the extracting the second set of features includes extracting a topic feature from each of the plurality of candidate text snippets in a candidate document based on the topic model.

14. The system of claim 8, wherein the obtaining a plurality of labeled training documents includes obtaining training documents and algorithmically generating labels for each of the training documents based on whether or not each of the plurality of labeled training documents contain one or more preset phrases.

15. A non-transitory machine-readable storage medium comprising instructions, which when implemented by one or more machines, cause the one or more machines to perform operations comprising:
obtaining a plurality of labeled training documents, each labeled training document containing a plurality of text snippets;
extracting a first set of features from each text snippet in each of the plurality of labeled training documents;
passing the extracted first set of features and the plurality of labeled training documents to a supervised machine learning algorithm to train a potential snippet relevance score model;
extracting a second set of features from each of a plurality of candidate text snippets in a candidate document;
calculating a relevancy score for each of the plurality of candidate text snippets using the potential snippet relevance score model; and
selecting one of the plurality of candidate text snippets to display based on the calculated relevancy scores.

16. The non-transitory machine-readable storage medium of claim 15, wherein the selecting includes:
ranking the plurality of candidate text snippets based on a combination of the calculated relevancy scores, relevancy of each candidate text snippet to a member profile corresponding to a member performing a search query, and relevancy of each candidate text snippet to the search query.

17. The non-transitory machine-readable storage medium of claim 15, further comprising:
passing the labeled training documents to a latent topic model unsupervised machine learning algorithm to generate a topic model based on the labeled training documents, a desired granularity of topics, and a desired number of topics.

18. The non-transitory machine-readable storage medium of claim 17, wherein the topic model includes a list of a plurality of different topics, and, for each of the plurality of different topics, a list of terms relevant to the corresponding topic and a. weight indicating the relevancy of each term to the corresponding topic.

19. The non-transitory machine-readable storage medium of claim 18, wherein the extracting the first set of features includes extracting a topic feature from each text snippet in each of the plurality of labeled training documents based on the topic model.

20. The non-transitory machine-readable storage medium of claim 18, wherein the extracting the second set of features includes extracting a topic feature from each of the plurality of candidate text snippets in a candidate document based on the topic model.
